(19) United States
(12) Patent Application Publication
(10) Pub. No.: US 2015/0119184 A1
(43) Pub. Date: Apr. 30, 2015

(54) Axles

(71) Applicant: PRM Marine Limited, Coventry (GB)

(72) Inventor: Martin Harris, Coventry (GB)

(21) Appl. No.: 14/526,411

(22) Filed: Oct. 28, 2014

(30) Foreign Application Priority Data
Oct. 29, 2013 (GB) 1319094.7

(51) Int. Cl. F16H 48/08; B60K 17/16

(52) U.S. Cl. CPC F16H 48/08; B60K 17/16; F16H 2700/02; F16H 2702/04
USPC 475/221

(57) ABSTRACT

An axle comprising: a housing including an interior surface defining a first cavity therein; a differential positioned within the first cavity of the housing; a first planetary gear system coupled to the differential and positioned within the first cavity of the housing.

### TECHNOLOGICAL FIELD

Embodiments of the present invention relate to axles. In particular, they relate to axles in tow tractors.

### BACKGROUND

Vehicles, such as tow tractors, usually include a power train that includes an engine, an axle and wheel hubs. The axle couples the engine to the wheel hubs and enables torque generated by the engine to be transferred to the wheel hubs to cause movement of the vehicle.

A vehicle may be arranged to carry or pull a load. For example, a tow tractor may be arranged to pull a load of baggage and/or freight. The load may result in the axle being subject to significant forces that may damage the axle. The repair or replacement of axles may be relatively time consuming and costly to the owner and/or operator of the vehicle.

It would therefore be desirable to provide an alternative axle.

### BRIEF SUMMARY

According to various, but not necessarily all, embodiments of the invention there is provided an axle comprising: a housing including an interior surface defining a first cavity therein; a differential positioned within the first cavity of the housing; a first planetary gear system coupled to the differential and positioned within the first cavity of the housing.

The axle may further comprise a gear system positioned outside of the housing and including an input connector for connecting to a propeller shaft, the gear system being coupled to the differential.

The housing may include an exterior surface defining a second cavity for receiving a propeller shaft therein.

The housing may include a first end and a second opposite end and having a center location between the first end and the second end. The differential may be positioned offset relative to the center location.

The axle may further comprise: a first axle shaft coupled to the first planetary gear system and positioned within the first cavity of the housing; and a first wheel hub coupled to the first axle shaft and positioned outside of the first cavity of the housing.

The axle may further comprise a second planetary gear system coupled to the differential and positioned within the first cavity of the housing.

The axle may further comprise: a second axle shaft coupled to the second planetary gear system and positioned within the first cavity of the housing; and a second wheel hub coupled to the second axle shaft and positioned outside of the first cavity of the housing.

The axle may be substantially cylindrical in shape and may have an axis, the differential and the first planetary gear system may be positioned along the axis.

The axle may further comprise a mounting connector including an array of apertures for receiving fasteners there through, the array of apertures may be arranged to enable the axle to be mounted on a plurality of different vehicles.

According to various, but not necessarily all, embodiments of the invention there is provided an axle comprising: a housing including an interior surface defining a first cavity, and an exterior surface defining a second cavity for receiving a propeller shaft therein; and a gear system positioned outside of the housing and including an input connector for connecting to the propeller shaft, the input connector being positioned adjacent to the second cavity.

The axle may further comprise a differential positioned within the first cavity of the housing and coupled to the gear system.

The housing may include a first end and a second opposite end and may have a center location between the first end and the second end, the differential being positioned offset relative to the center location.

The axle may further comprise a first planetary gear system coupled to the differential and positioned within the first cavity of the housing.

The axle may further comprise: a first axle shaft coupled to the first planetary gear system and positioned within the first cavity of the housing; and a first wheel hub coupled to the first axle shaft and positioned outside of the first cavity of the housing.

The axle may further comprise a second planetary gear system coupled to the differential and positioned within the first cavity of the housing.

The axle may further comprise: a second axle shaft coupled to the second planetary gear system and positioned within the first cavity of the housing; and a second wheel hub coupled to the second axle shaft and positioned outside of the first cavity of the housing.

The axle may further comprise a mounting connector including an array of apertures for receiving fasteners there through, the array of apertures being arranged to enable the axle to be mounted on a plurality of different vehicles.

The axle may be substantially cylindrical in shape.

According to various, but not necessarily all, embodiments of the invention there is provided a power train comprising an axle as described in any of the preceding paragraphs.

According to various, but not necessarily all, embodiments of the invention there is provided a vehicle comprising an axle as described in any of the preceding paragraphs. The vehicle may be a tow tractor.

### BRIEF DESCRIPTION

For a better understanding of various examples that are useful for understanding the brief description, reference will now be made by way of example only to the accompanying drawings in which:

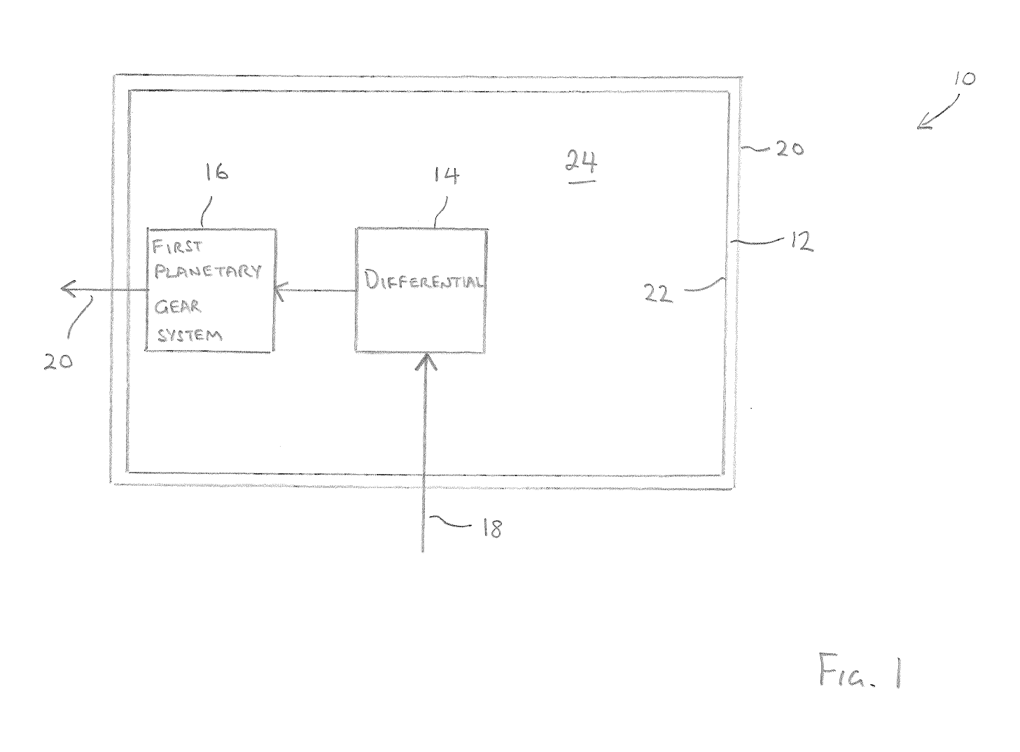

FIG. 1 illustrates a schematic diagram of an axle according to an example;

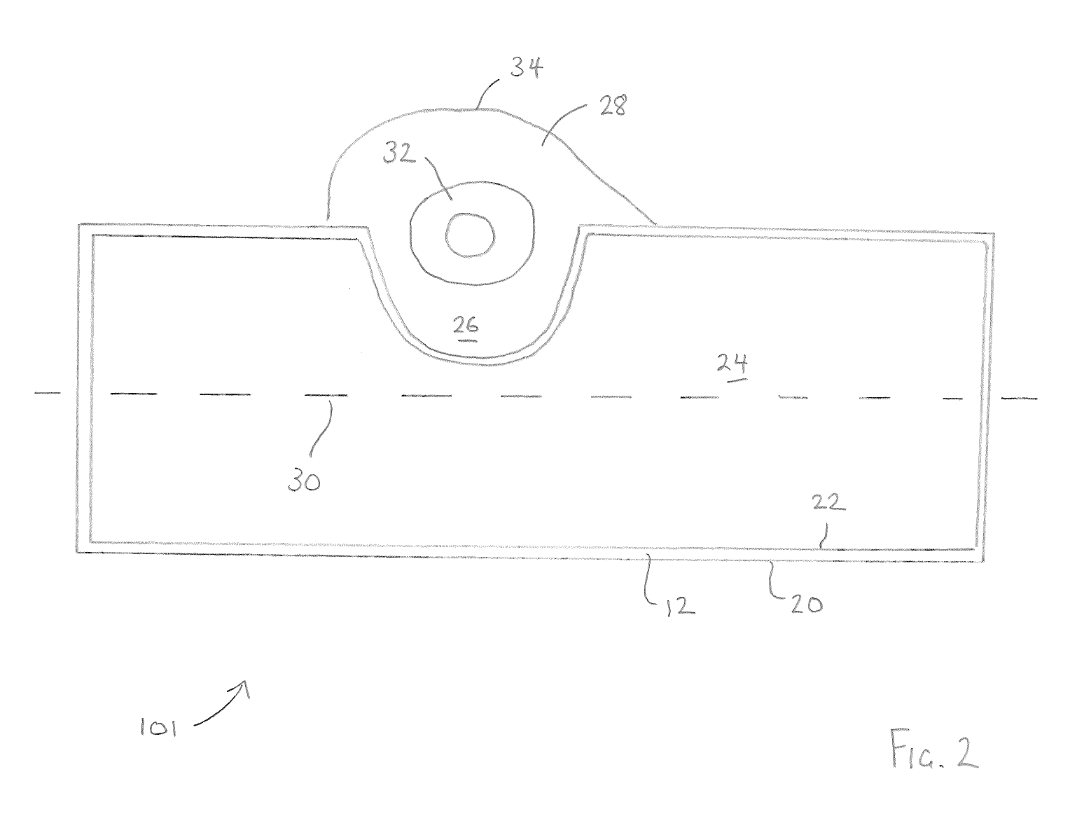

FIG. 2 illustrates a side view diagram of another axle according to an example;

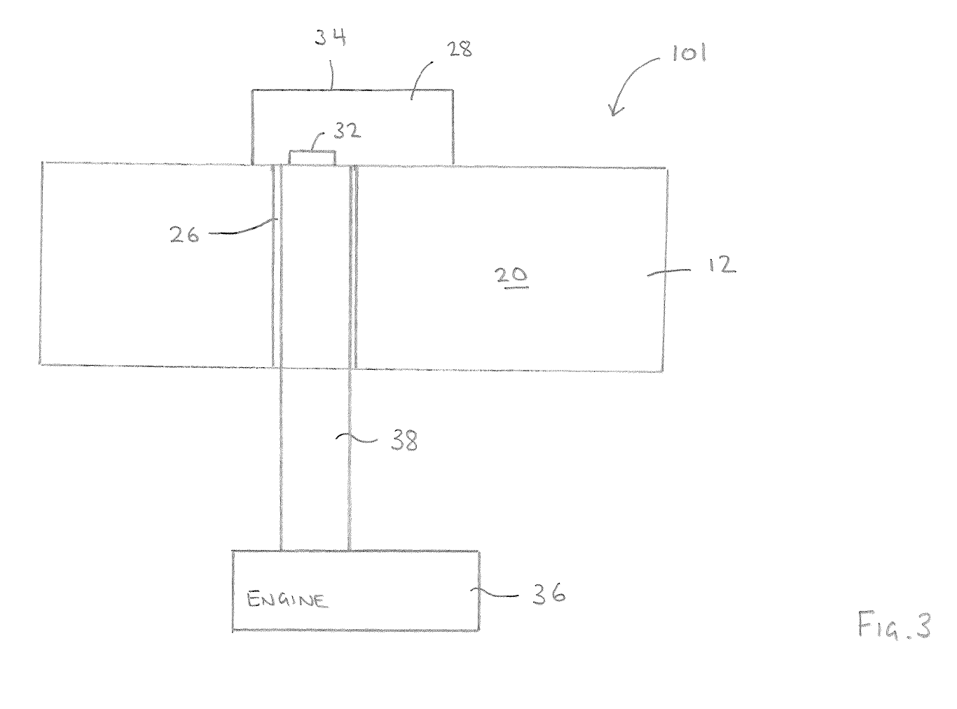

FIG. 3 illustrates a plan view diagram of the axle illustrated in FIG. 2;

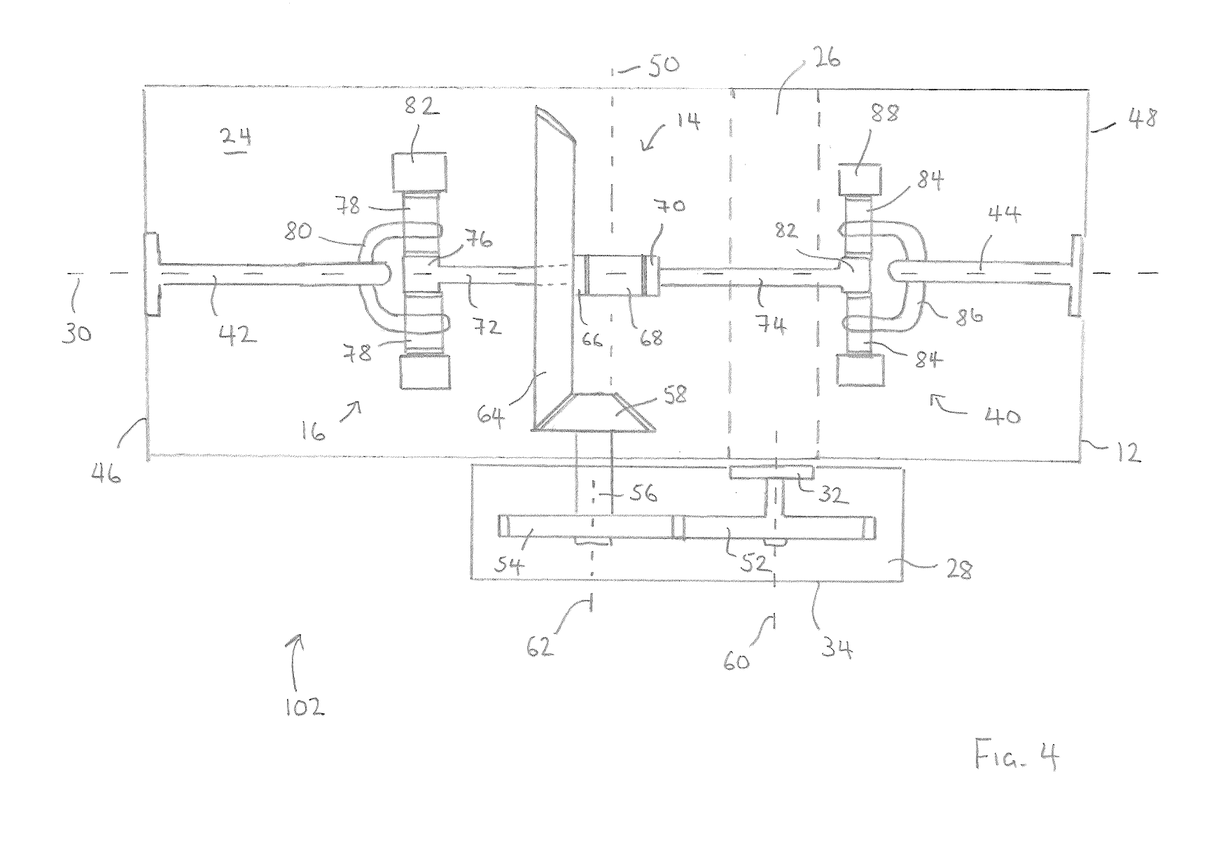

FIG. 4 illustrates a plan view cross sectional diagram of a further axle according to an example;

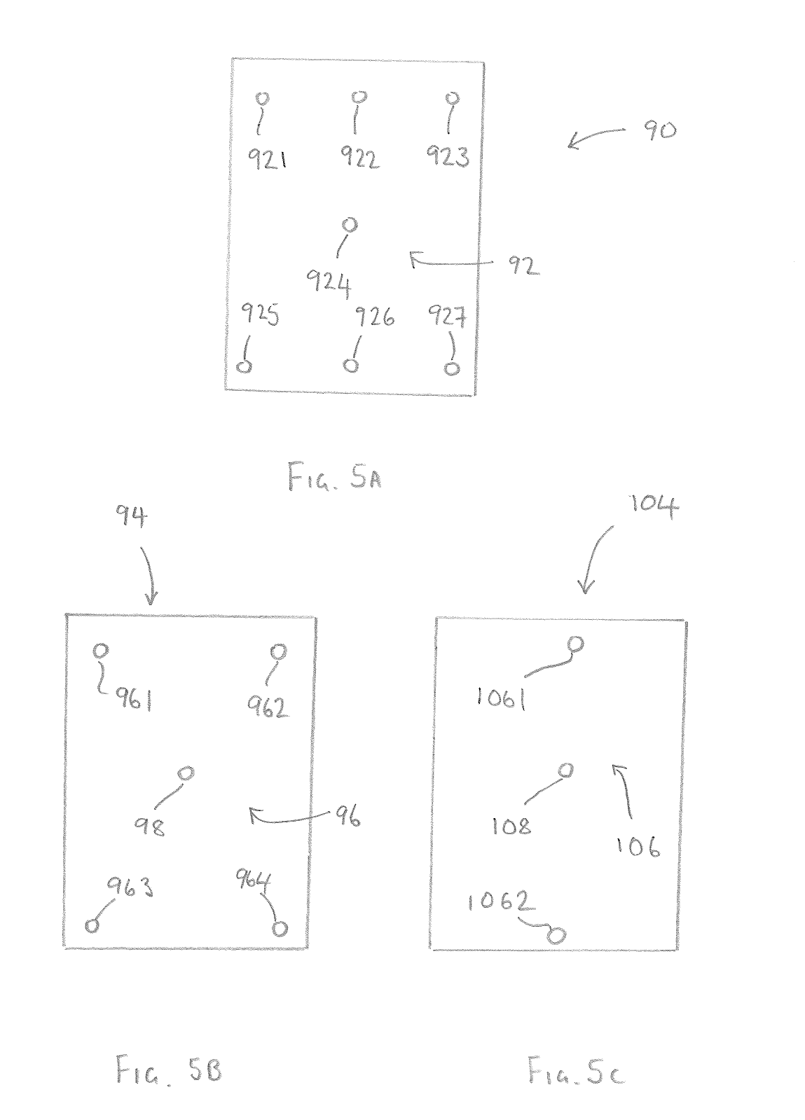

FIG. 5A illustrates a plan view diagram of a mounting connector according to an example;

FIG. 5B illustrates a plan view diagram of a first connector for connecting to the mounting connector illustrated in FIG. 5A;

FIG. 5C illustrates a plan view diagram of a second connector for connecting to the mounting connector illustrated in FIG. 5A; and

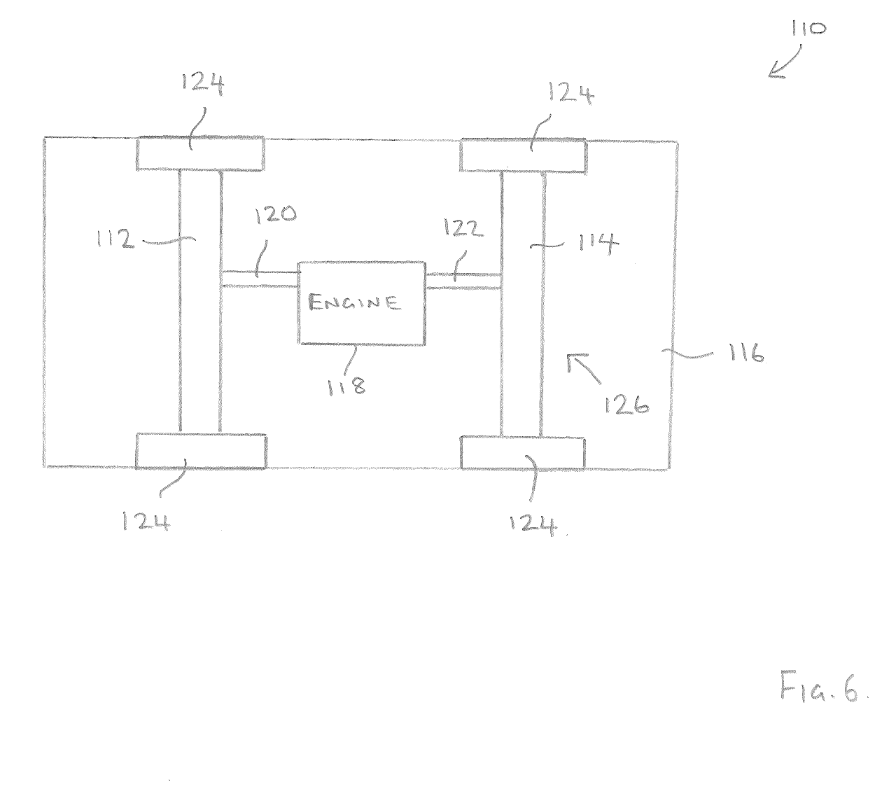

FIG. 6 illustrates a plan view diagram of a vehicle including an axle according to an example.

### DETAILED DESCRIPTION

In the following description, the wording ‘connect’ and ‘couple’ and their derivatives mean operationally connected or coupled. It should be appreciated that any number or combination of intervening components can exist (including no intervening components).

FIG. 1 illustrates a schematic diagram of an axle 10 according to an example. The axle 10 includes a housing 12, a differential 14 and a first planetary gear system 16. The axle 10 may be relatively cylindrical in shape and may therefore be referred to as a ‘cylinder axle’. The axle 10 is arranged to receive torque 18 from a source (not illustrated in FIG. 1) such as a propeller shaft (which may also be referred to as a drive shaft) or from a gear system. The axle 10 is also arranged to provide torque 20 to a further component such as a wheel hub (not illustrated in FIG. 1).

The axle 10 may be a module. As used here ‘module’ refers to a unit or apparatus that excludes certain parts/components that would be added by an end manufacturer or a user. For example, a second planetary gear system may be added to the axle 10 for receiving torque from the differential 14 and for providing torque to a further component such as a wheel hub.

The housing 12 includes an exterior surface 20 and an interior surface 22. The exterior surface 20 defines an exterior surface of the axle 10 and has a substantially cylindrical shape. The interior surface 22 of the housing 12 defines a cavity 24 therein. The housing 12 is arranged to house at least some of the components of the axle 10 within the cavity 24.

The differential 14 is a gearing system that is arranged to receive torque 18 from a source (such as a propeller shaft or gear system) and provide the torque to the first planetary gear system 16 and to the second planetary gear system, where present. The differential 14 is located within the cavity 24 of the housing 12. The differential 14 may have any suitable gear structure and may include, for example, a ring gear including a carrier, a first sun gear coupled to the first planetary gear system 16, a second sun gear coupled to (or for coupling to) the second planetary gear system and a planet gear.

The first planetary gear system 16 is a gearing system that is arranged to receive torque from the differential 14 and provide torque 20 to a further component (a wheel hub for example) coupled to the first planetary gear system 16. The first planetary gear system is located within the cavity 24 of the housing 12 and may therefore be referred to as a first in-board planetary gear system. The first planetary gear system 16 may have any suitable gear structure and may include, for example, a sun gear, a plurality of planet gears, a planet gear carrier and a ring gear.

Where present, the second planetary gear system is also arranged to receive torque from the differential 14 and provide the torque to a further component. The second planetary gear system may be located within the cavity 24 of the housing 12 and may be referred to as a second in-board planetary gear system. In other examples, the second planetary gear system may be located outside the cavity 24 of the housing 12 and may instead be located in a separate housing (such as in a housing for a wheel hub).

The axle 10 may be advantageous in that since the first planetary gear system 16 and the second planetary gear system may be housed within the housing 12, the housing 12 may form a single solid cylinder that has less oil leakage.

FIG. 2 illustrates a side view diagram of another axle 101 according to an example. The axle 101 is similar to the axle 10 illustrated in FIG. 1 and where the features are similar, the same reference numerals are used. The axle 101 differs from the axle 10 in that the exterior surface 20 of the housing 12 defines a second cavity 26 and in that the axle 101 includes a gearing system 28. Once again, the housing 12 is substantially cylindrical in shape and the axle 101 may therefore be referred to as a ‘cylinder axle’.

The second cavity 26 forms a hollow or depression in the exterior surface 20 of the housing 12 and is sized and shaped to receive a propeller shaft therein. The second cavity 26 may extend perpendicularly to the longitudinal axis 30 of the housing 12.

The gear system 28 may have any suitable gear structure and is at least partially positioned outside of the housing 12 (i.e. at least some of the gear system 28 is not positioned within the first cavity 24). The gear system 28 includes an input connector 32 for connecting to a propeller shaft, a housing 34 for housing at least some of the gear structure of the gear system 28, and an output shaft (not illustrated in FIG. 2) for coupling to a differential. The input connector 32 is positioned adjacent to the second cavity 26 to connect to a propeller shaft in the second cavity 26.

FIG. 3 illustrates a plan view diagram of the axle 101 illustrated in FIG. 2, an engine 36 and a propeller shaft 38. The engine 36 may be any suitable engine or motor that produces torque. The engine 36 is connected to the propeller shaft 38 that extends from the engine 36, into the second cavity 26 of the axle 101, and is connected to the input connector 32 of the gear system 28. The engine 36 and the axle 101 may also be connected via a gear box in some examples.

The axle 101 provides an advantage in that since the input connector 32 is positioned adjacent to the second cavity 26, the axle 101 may be fitted to vehicles where the vertical distance between the propeller shaft 38 and the wheel hubs is relatively small. By selecting an appropriate depth for the second cavity 26 and by positioning the input connector 32 adjacent the second cavity 26, the axle 101 may be retrofitted to a large variety of different vehicles. Due to the above mentioned arrangement, it should be appreciated that the axle 101 may occupy a relative small space within a vehicle.

FIG. 4 illustrates a plan view cross sectional diagram of a further axle 102 according to an example. The axle 102 is similar to the axle 10 and the axle 101 illustrated in FIGS. 1 and 2 respectively and where the features are similar, the same reference numerals are used. The axle 102 includes the features of in-board planetary gear systems (as described above with reference to FIG. 1), and a housing 12 defining a second cavity 26 for receiving a propeller shaft (as described above with reference to FIGS. 2 and 3).

In more detail, the axle 102 includes a housing 12, a first gear system 28, a differential 14, a first planetary gear system 16, a second planetary gear system 40, a first axle shaft 42, and a second axle shaft 44.

The housing 12 is substantially cylindrical in shape and consequently, the axle 102 may be referred to as a cylinder axle. The differential 14, the first planetary gear system 14, the second planetary gear system 40, the first axle shaft 42 and the second axle shaft 44 are housed within the first cavity 24 of the housing 12. The housing 12 also defines a second cavity 26 for receiving a propeller shaft therein.

The housing 12 includes a first end 46 and a second opposite end 48 and has a center location (represented by the dotted line 50) half way between the first end 46 and the second end 48. The second cavity 26 is offset relative to the center 50 of the housing 12 and is defined between the center 50 and the second end 48.

The first gear system 28 includes a housing 34, an input connector 32 (which is an input flange in this example), an input pinion 52, an input wheel 54, an output shaft 56 and a spiral bevel pinion 58. The housing 34 is separate to the housing 12 and houses the input pinion 52 and the input wheel 54.

The input flange 32 extends from the housing 34 and is arranged to connect to a propeller shaft. The input pinion 52 is connected to the input flange 32 and is arranged to rotate about an axis 60. The input pinion 52 engages the input wheel 54 and is arranged to rotate the input wheel 54 about an axis 62. The input pinion 52 and the input wheel 54 may have any suitable gear ratio and may have a gear ratio of 1:1 or 1.26:1 for example. The output shaft 56 is connected to the input wheel 54 and extends from the housing 34 and into the housing 12. The spiral bevel pinion 58 is connected to the output shaft 56 and is therefore positioned within the housing 12. The spiral bevel pinion 58 is arranged to rotate about the axis 62.

The differential 14 includes a ring gear 64 including a carrier (not illustrated to maintain the clarity of FIG. 4), a first sun gear 66, a second sun gear 68 and a planet gear 70.

The spiral bevel pinion 58 of the first gear system 28 engages the ring gear 64 of the differential 14 and is arranged to rotate the ring gear 64 about the axis 30. The planet gear 68 is coupled to the planet carrier of the ring gear 64 and rotates about the axis 30. The planet gear 68 engages the first sun gear 66 and the second sun gear 70 and is arranged to rotate them about the axis 30. The first sun gear 66 is connected to a shaft 72 that extends from the first sun gear 66 parallel to the axis 30 and towards the first end 46. The second sun gear 70 is connected to a shaft 74 that extends from the second sun gear 70 parallel to the axis 30 and towards the second end 48. The differential 14 may have any suitable gear ratio and may have a gear ratio of 2.82:1 for example.

It should be appreciated that the differential 14 is offset relative to the center 50 of the housing 12 due to the location of the second cavity 26. In particular, the differential 14 has a center that is positioned between the center 50 and the first end 46 of the housing 12.

The first planetary gear system 16 is an in-board planetary gear system and includes a sun gear 76, a plurality of planet gears 78, a planet carrier 80 connected to the planet gears 78 and a ring gear 82. The first planetary gear system 16 may have any suitable gear ratio and may have a gear ratio of 5.6:1 for example.

The sun gear 76 is connected to the shaft 72 and is arranged to rotate about the axis 30. The sun gear 76 engages the plurality of planet gears 78 and is arranged to rotate planet gears 78 (and consequently the planet carrier 80) about the axis 30. The planet carrier 80 is connected to the first axle shaft 42 and is arranged to rotate the first axle shaft 42 about the axis 30. The first axle shaft 42 may be connected to a wheel hub.

The second planetary gear system 40 is an in-board planetary gear system and includes a sun gear 82, a plurality of planet gears 84, a planet carrier 86 connected to the planet gears 84 and a ring gear 88. The second planetary gear system 40 may have any suitable gear ratio and may have a gear ratio of 5.6:1 for example.

The sun gear 82 is connected to the shaft 74 and is arranged to rotate about the axis 30. The sun gear 82 engages the plurality of planet gears 84 and is arranged to rotate planet gears 84 (and consequently the planet carrier 86) about the axis 30. The planet carrier 86 is connected to the second axle shaft 44 and is arranged to rotate the second axle shaft 44 about the axis 30. The second axle shaft 44 may be connected to a wheel hub.

The axle 102 provides an advantage in that the axle 102 includes three gear stages, namely the first gear system 28 (the first gear stage), the differential 14 (the second gear stage), and the first and second planetary gear systems 16, 40 (the third gear stage). The three gear stages may advantageously reduce the stress on the axle 102 and increase the longevity of the axle 102. Additionally, since the axle 102 includes the features of the axle 10 illustrated in FIG. 1, and the features of the axle 101 illustrated in FIG. 2, the axle 102 provides the same advantages as those mentioned above with reference to FIGS. 1, 2 and 3.

FIG. 5A illustrates a plan view diagram of a mounting connector 90 according to an example. The mounting connector 90 is connected to the exterior surface 20 of the housing 12 of the axle 10, 101, 102 and in some examples, the mounting connector 90 may be an integral part of the housing 12 (in other words, the mounting connector 90 is formed in the same casting as the housing 12). An axle 10, 101, 102 may include a plurality of mounting connectors 90. For example, the axle 102 may include a first mounting connector 90 between the first planetary gear system 16 and the first end 46, and a second mounting connector 90 between the second planetary gear system 40 and the second end 48.

The mounting connector 90 includes an array of apertures 92 for receiving fasteners there through. The array of apertures 92 is arranged to enable the axle 10, 101, 102 to be mounted on a plurality of different vehicles having different connectors for mounting the axle 10, 101, 102. In particular, the array of apertures 92 includes a first row of apertures 921, 922, 923, a second row of apertures 925, 926, 927 and an aperture 924 between the first and second rows of apertures.

FIG. 5B illustrates a plan view diagram of a first connector 94 for connecting to the mounting connector 90 illustrated in FIG. 5A. The first connector 94 may also be referred to as a ‘leaf spring’. The first connector 94 includes an array of fasteners 96 (U bolts in this example) and a centralizing pip 98. The array of fasteners 96 includes a first fastener 961, 962 and a second fastener 963, 964. The centralizing pip 98 is positioned between the first and second rows of fasteners.

In order to mount an axle 10, 101, 102 to a vehicle, the mounting connector 90 is brought into contact with the first connector 94 so that the first fastener 961, 962 is inserted through the apertures 921, 923, the centralizing pip 98 is inserted into the aperture 924 and the second fastener 963, 964 is inserted into the apertures 925, 927.

FIG. 5C illustrates a plan view diagram of a second connector 104 for connecting to the mounting connector 90 illustrated in FIG. 5A. The second connector 104 includes an array of fasteners 106 (bolts in this example) and a rubber bushing 108. The array of fasteners 106 includes a first fastener 1061 and a second fastener 1062. The rubber bushing 108 is positioned between the first and second fasteners 1061, 1062.

In order to mount an axle 10, 101, 102 to a vehicle, the mounting connector 90 is brought into contact with the second connector 104 so that the first fastener 1061 is inserted through the aperture 922, the rubber bushing 108 is inserted into the aperture 924 and the second fastener 1062 is inserted into the aperture 926.

FIG. 6 illustrates a plan view diagram of a vehicle 110 including a first axle 112, a second axle 114, a chassis 116, an engine 118, a first propeller shaft 120, a second propeller shaft 122 and wheels 124. In some examples, the engine 118 may not be connected to the axle 114 and consequently, the second propeller shaft 120 may not be present in these examples. The first axle 112, the second axle 114, the chassis 116, the engine 118, the first propeller shaft 120, the second propeller shaft 122 may be referred to as a power train 126 or a drive train 126.

The engine 118 is mounted to the chassis 116 and is connected to the first and second axles 120, 122 via the first and second propeller shafts 120, 122 respectively. The engine 118 may be connected to the first axle 120 via a gear box. The first and second axles 120, 122 are mounted to the chassis 116 and may be mounted via one or more mounting connectors 90. The first axle 112 is an axle 10, 101, 102 as described in the preceding paragraphs and is arranged to provide torque to wheels 124. The second axle 114 may be an axle 10, 101, 102 as described in the preceding paragraphs, and is arranged to provide torque to the wheels 124. In other examples, the second axle 114 may be a conventional axle and may not be connected to the engine 118.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples.

Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An axle comprising:
a housing including an interior surface defining a first cavity therein;
a differential positioned within the first cavity of the housing;
a first planetary gear system coupled to the differential and positioned within the first cavity of the housing.

2. An axle as claimed in claim 1, further comprising a gear system positioned outside of the housing and including an input connector for connecting to a propeller shaft, the gear system being coupled to the differential.

3. An axle as claimed in claim 1, wherein the housing includes an exterior surface defining a second cavity for receiving a propeller shaft therein.

4. An axle as claimed in claim 3, wherein the housing includes a first end and a second opposite end and having a center location between the first end and the second end, the differential being positioned offset relative to the center location.

5. An axle as claimed in claim 1, further comprising: a first axle shaft coupled to the first planetary gear system and positioned within the first cavity of the housing; and a first wheel hub coupled to the first axle shaft and positioned outside of the first cavity of the housing.

6. An axle as claimed in claim 1, further comprising a second planetary gear system coupled to the differential and positioned within the first cavity of the housing.

7. An axle as claimed in claim 6, further comprising: a second axle shaft coupled to the second planetary gear system and positioned within the first cavity of the housing; and a second wheel hub coupled to the second axle shaft and positioned outside of the first cavity of the housing.

8. An axle as claimed in claim 1, wherein the axle is substantially cylindrical in shape and has an axis, the differential and the first planetary gear system being positioned along the axis.

9. An axle as claimed in claim 1, further comprising a mounting connector including an array of apertures for receiving fasteners there through, the array of apertures being arranged to enable the axle to be mounted on a plurality of different vehicles.

10. An axle comprising:
a housing including an interior surface defining a first cavity, and an exterior surface defining a second cavity for receiving a propeller shaft therein; and
a gear system positioned outside of the housing and including an input connector for connecting to the propeller shaft, the input connector being positioned adjacent to the second cavity.

11. An axle as claimed in claim 10, further comprising a differential positioned within the first cavity of the housing and coupled to the gear system.

12. An axle as claimed in claim 11, wherein the housing includes a first end and a second opposite end and having a center location between the first end and the second end, the differential being positioned offset relative to the center location.

13. An axle as claimed in claim 11, further comprising a first planetary gear system coupled to the differential and positioned within the first cavity of the housing.

14. An axle as claimed in claim 13, further comprising: a first axle shaft coupled to the first planetary gear system and positioned within the first cavity of the housing; and a first wheel hub coupled to the first axle shaft and positioned outside of the first cavity of the housing.

15. An axle as claimed in claim 11, further comprising a second planetary gear system coupled to the differential and positioned within the first cavity of the housing.

16. An axle as claimed in claim 15, further comprising: a second axle shaft coupled to the second planetary gear system and positioned within the first cavity of the housing; and a second wheel hub coupled to the second axle shaft and positioned outside of the first cavity of the housing.

17. An axle as claimed in claim 10, further comprising a mounting connector including an array of apertures for receiving fasteners there through, the array of apertures being arranged to enable the axle to be mounted on a plurality of different vehicles.

18. An axle as claimed in claim 10, wherein the axle is substantially cylindrical in shape.

19. (canceled)

20. A power train comprising an axle as claimed in claim 1.

21. A vehicle comprising an axle as claimed in claim 1.

22. (canceled)
